(19) United States
(12) Patent Application Publication
(10) Pub. No.: US 2009/0079211 A1
(43) Pub. Date: Mar. 26, 2009

(54) Always clean, portable dog waste scoop and bag

(76) Inventor: Thomas Eugene Colaiano, Denver, CO (US)

Correspondence Address: Thomas Eugene Colaiano, P.O.Box 1941, Wheat Ridge, CO, 80034, US

(21) Appl. No.: 11/903,902

(22) Filed: Sep. 26, 2007

(51) Int. Cl. A01K 29/00

(52) U.S. Cl. 294/1.3

(57) ABSTRACT

This invention is a portable device for picking up dog waste. The scoop and paddle always stay clean because they are protected by used, or recycled grocery, newspaper or produce plastic bags. The waste scoop, paddle, and bag can be attached to and carried on a person's belt or can even be attached to the dog collar. The device always hangs vertically because the dip contains a swivel mechanism that allows the scoop and bag to flow freely while walking or jogging. There is a nylon bag attached that temporarily holds the disposable plastic bag until disposed. The paddle and scoop are reusable endlessly and always sanitary. You do not have to replace any part of this unit after use except the disposable bags.

### CROSS REFERENCE TO RELATED APPLICATION

Not applicable

### FEDERALLY SPONSORED RESEARCH

Not applicable

### SEQUENCE LISTING OR PROGRAM

Not applicable

### BACKGROUND OF THE INVENTION

1. Field of Invention

This invention relates to dog waste pick up, containment, and then disposal, specifically, this device always stays clean and can be used over and over. Most municipalities have laws that relate to the clean up and disposal of pet waste. For example, the City of San Francisco's Health Code under Article 40 states: “It shall be unlawful for an owner or custodian of any dog who permits the dog to defecate on public or private property or who walks a dog without carrying a container suitable for the removal and disposal of excrement.”

2. Prior Art

There are a great number of prior devices which have been disclosed for use in picking up dog waste: During this particular process there have been many patents investigated and compared: For example, see U.S. Pat. Nos. 3,984,139; 4,014,587; 4,056,278; 4,323,272; 5,564,762; 5,482,337; 5,405,050; 5,406,572; 5,385,376; 5,315,960; 5,054,825; 4,969,419; 4,909,505; 4,896,912; 4,796,327; 4,447,082; 5,564,763; 5,584,519; 5,624,671; 5,864,883; 6,039,369; 6,048,008; 6,135,057; 6,386,605; 6,485,073.

These previous devices are different from this invention because of several reasons:

1. Many are more costly.
2. They may require complicated assembly each time they are used.
3. They often leave waste on exposed surfaces.
4. Some are awkward, cumbersome, bulky, hard to carry or even hazardous while walking or jogging.
5. Many cannot be used on varying terrain or any surface.
6. Many do not use disposable, recyclable plastic bags and require custom made bags to be purchased.
7. Some do not accommodate various size of waste.
8. Many are unsightly when full.
9. Most cannot be made reasonably odor-free, or leak-proof.
10. Many need to be cleaned after each use.
11. Some are made of cardboard, paperboard, or woodboard and are dependent on double-sided tape for proper function and use.

While a number of inventions address various methods of waste pick up, containment, and disposal, none of the prior devices are as functional, sleek, well-made, comfortable to carry by attaching to belt or dog collar, always stay clean and sanitary, are as lightweight and safe for walking or jogging while carrying. This device always stays clean because of the use of any recycled, disposable plastic bags that do not need to be purchased.

### BRIEF DESCRIPTION OF DRAWINGS

FIG. 1 and FIG. 1(a) Total Assembly: FIG. 1 is a top view of the total assembly with bag attached. FIG. 1(a) is a side view of the total assembly without the bag. For detailed descriptions, including specific dimensions, for each part see following figures under Drawings.

FIG. 2 Portable Scoop: This includes top view, side view, and back view with dimensions.

FIG. 3 Paddle: This has top view, side view, and back with specific dimensions.

FIG. 4 Carry Bag: This is top, side and front views with dimensions.

FIG. 5 Removable Bag Fastener: This figure has front, side and top views with dimensions.

FIG. 6 Belt Loop and Swivel Mechanism: This figure shows both the belt loop, and swivel mechanism from front, side and top views with dimensions.

### DETAILED DESCRIPTIONS OR EMBODIMENTS

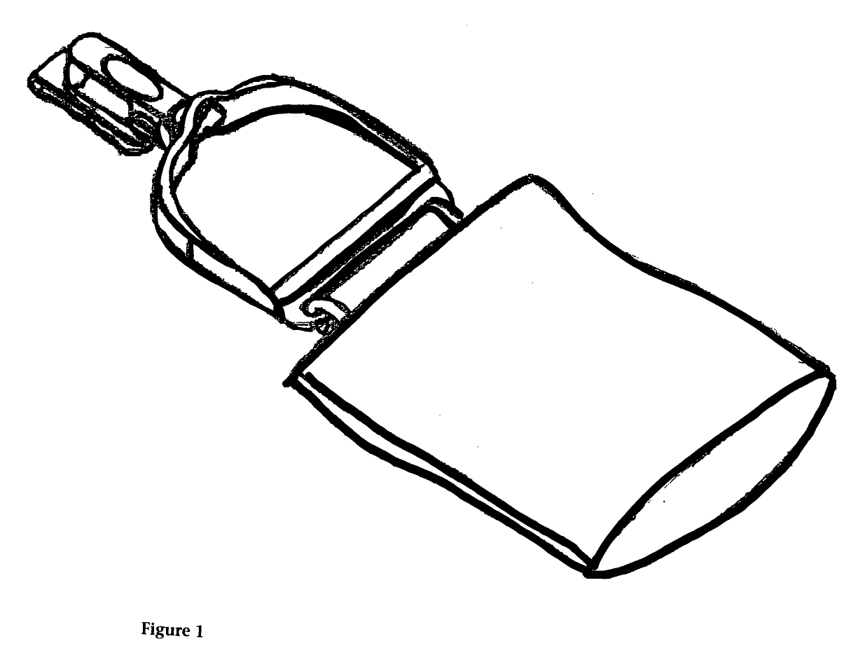

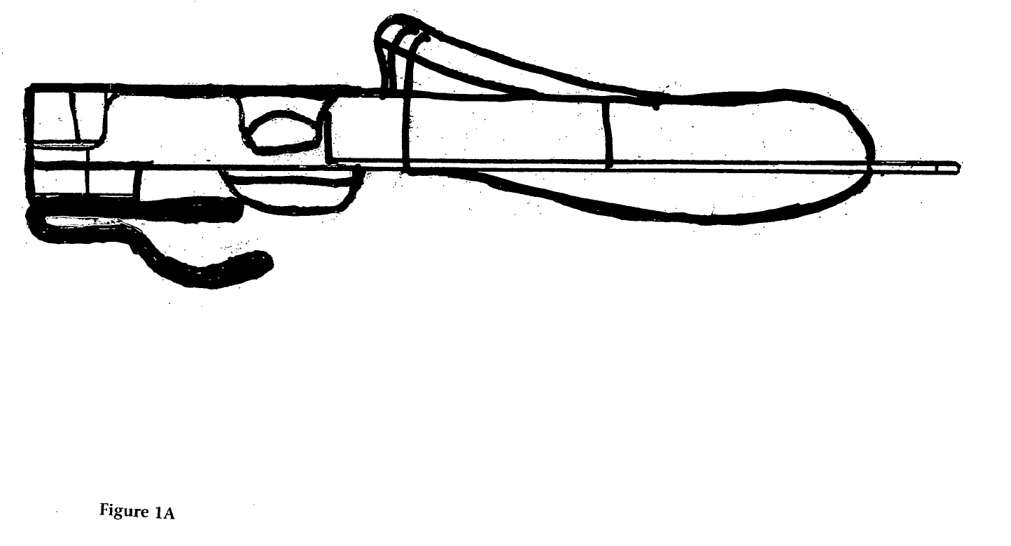

FIG. 1 is a drawing of the Total Assembly of the invention. Notice the scoop, paddle, removable bag fastener, belt loop and swivel are all made of polypropylene plastic and have smooth, rounded edges and corners. They are designed ergonomically to fit the human hand in a comfortable fashion. The Total Assembly or device is comprised of six parts plus two disposable, recycled plastic bags. Each part fits into each other as a male/female connection to make one self-contained unit. It has a belt loop with a swivel for the purpose of attaching to the person's belt, the dog's collar or to a retractable mechanism on a retractable dog leash. It has a portable scoop and paddle that attach to the belt loop. A nylon bag with button snaps, with an open top to allow easy access for carrying waste until disposed. The paddle, scoop, and nylon bag always stay clean and sanitary because of the use of the recycled plastic bag during pick up.

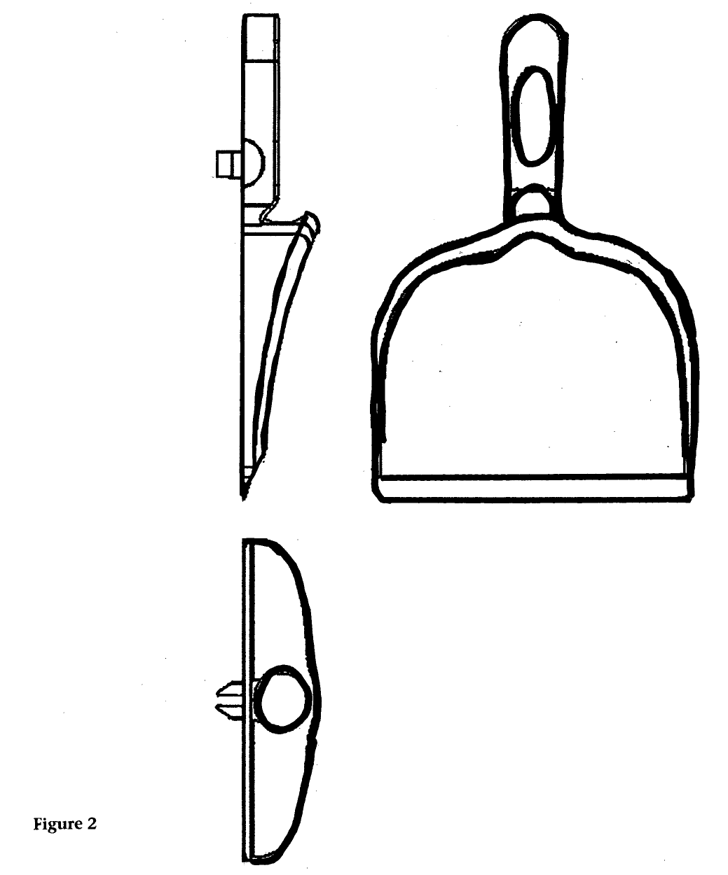

FIG. 2 The Portable Scoop: which shows three views: top, side and back. The dimensions are specifically identified. It measures 6.02 inches in length and paddle width is 4 inches. The handle is 2.67 inches long, It has a handle with a thumb indentation for a pressure point to hold the end of plastic bag. The scoop shape is more rounded to allow more space on the paddle. It has a bulkhead on three sides to contain the waste, and a hole on the top side, roughly finger sized, to enable the bag to be pushed through the raised lip to the thumb indentation. It has a gradual slope from one end to the end of the bulkhead. The scoop and handle are rounded and smooth finished and are designed to snap together securely into the bag holder. The surface has a raised lip around three sides. All parts of the handle are smooth, rounded and made of polypropylene plastic.

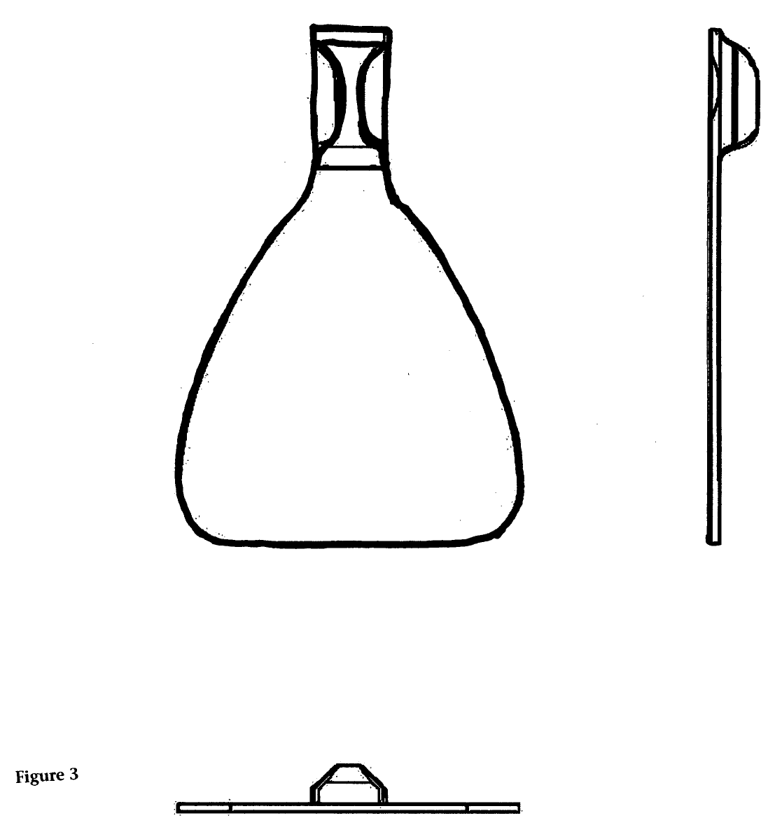

FIG. 3 The Paddle: showing three sides: top, side and front views with specific dimensions. The surface of the paddle is flat, smooth and is slightly smaller in length and smaller in width which enables it to easily fit inside the portable scoop. The handle of the paddle is also shortened in length and smaller in width; it has rounded edges and a thumb indentation as well. The handle is tapered at the top to conform to a hand. A disposable bag fits over the paddle section to protect it from excrement.

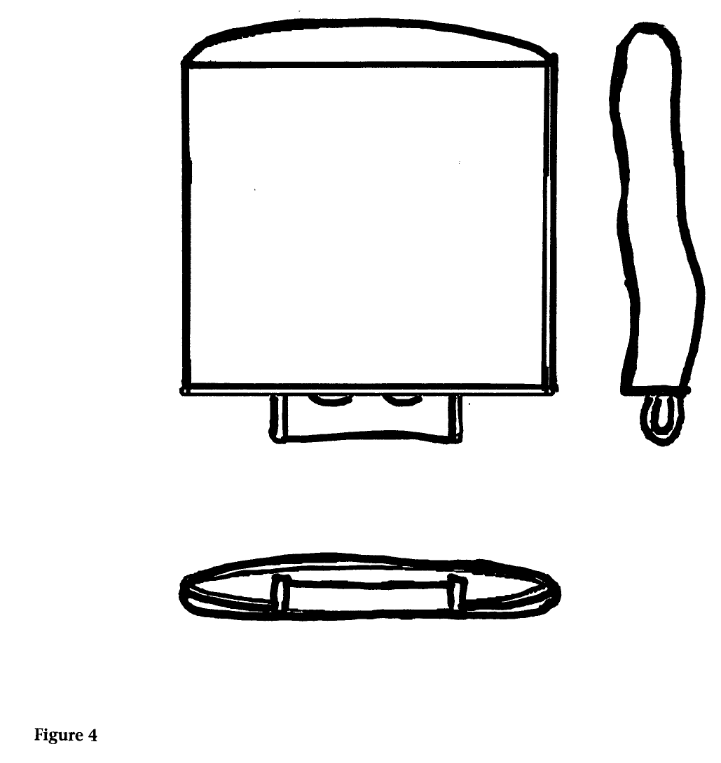

FIG. 4 is the drawing of the carry bag with a top, front and side view and specific dimensions. This part is made of nylon, is 6.25 in width and 6.25 in length and has an open top that has 2 button snaps that allow it to be attached to the holder. The open top allows easy access for temporarily carrying the recycled plastic bag with waste until disposal is possible.

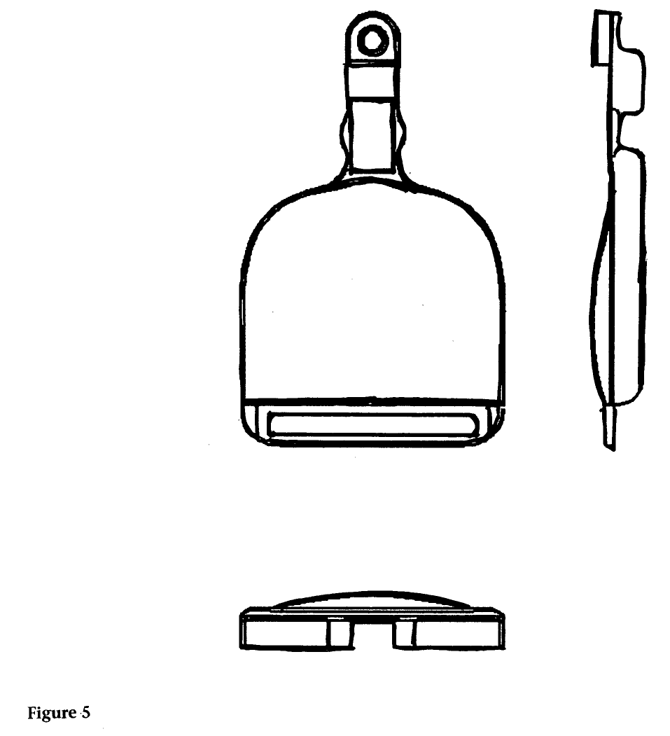

FIG. 5 is a drawing of the removable bag fastener with top, side and front views and specific dimensions, This is basically a frame assembly which enables everything to fit together and be carried along with bag. It is designed with a slight vertical curve on the back side for comfort while carrying. It has a notch and a hole for the back of the paddle handle to snap through. There is a square cut-out on the side of the frame handle for fingers to easily remove the paddle and scoop from this frame with pressure.

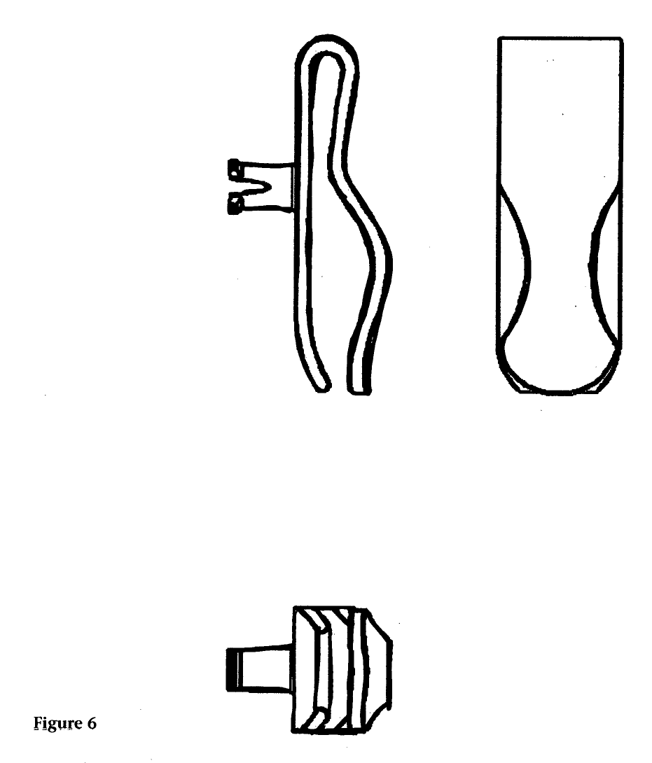

FIG. 6 is a drawing of the belt loop and the swivel mechanism, showing a front, side and back view with dimensions. This part is the plastic top that can be used for the fastening to a belt, collar or retractable leash mechanism. It is designed to swing freely and hang vertically on the person or the dog at all times. The swivel is located at the center top portion. The small plastic dowel is permanently affixed to the belt loop. The swivel mechanism is a plastic dowel, smaller in circumference than the hole in the removable bag fastener. It is long enough to go through the hole and protrude slightly. The tip of the dowel is slightly larger in circumference thereby enabling it to pass through the hole in the removable bag fastener. The purpose of this design is to allow the total assembly to hang and swing freely while walking or jogging. The end of the swivel has a tight opening to allow for a belt or leash. It is 7.0 inches long. The second part is designed to fit the retractable leash handle mechanism. It is curved and longer but is part of the same piece. The overall length of the loop is 1.69 inches.

### CONCLUSION

This invention is a one of a kind, well-designed unit or device for the sanitary pick up of dog waste, inconspicuous containment and transport of the waste until disposed. The main parts never have to be cleaned and the device uses a disposable, recycled plastic bag which does not need to be custom made or purchased. Another added feature is the fact that the device can be carried by the person or by the dog and it is lightweight, comfortable and safe to have attached while walking or jogging. There are no long handles or sharp edges and, in fact, the device looks sleek and fashionable. This is one complete unit that serves its purpose while always staying clean and sanitary.

I claim:

1. Total Assembly of the invention. Notice the scoop, paddle, removable bag fastener, belt loop and swivel are all made of polypropylene plastic and have smooth, rounded edges and corners. They are designed ergonomically to fit the human hand in a comfortable fashion. The Total Assembly or device is comprised of six parts and a disposable, recycled plastic bag. Each part fits into each other as a male/female connection to make one self-contained unit. It has a belt loop with a swivel for the purpose of attaching to the person's belt, to the dog's collar or to a retractable leash mechanism. It has a portable scoop and paddle that attach to the belt loop. A nylon bag interlocks for carrying waste until disposed. The paddle, scoop, and nylon bag always stay clean and sanitary because of the use of the recycled plastic bag during pick up.
Total Assembly Process:
Step 1. Take the closed end of the recycled, plastic bag with your index finger and thread it through to hole in the top of the curved section of the paddle.
Extend it far enough to be able to grab the bag and handle by the indentation on the handle. Put thumb pressure on the thumb indentation, while holding plastic bag in place.
Step 2. Detach the paddle from the scoop.
Step 3. Use other hand and place in the open part of the bag and reverse the bag inside out over the scoop so it is completely covered by the bag and leaves a fold for the paddle. Let your index finger hold the side of the bag to the handle with pressure.
Step 4. Insert paddle to the inside top fold of the plastic bag. Then straddle the waste to be picked up while pulling paddle and scoop together so the waste is now inside and in the back part of the scoop and reversed bag.
Step 5. After the waste has been scooped into the bag, start releasing finger that is holding back of bag and at the same time, pull bag up until it is turned to the original side and then pull bag out of holder. Waste stays at the bottom of the bag.
Step 6. Insert plastic bag into the portable nylon carry bag until able to dispose.
Now continue walking or jogging without an unsightly bag of waste, which is now concealed in a sleek, fashionable nylon bag.
The Portable Scoop. It measures 6.02 inches in length and 4.0 inches in width. The handle is 2.67 inches long. It has a handle with a thumb indentation for a pressure point to hold the end of the recycled plastic bag. The scoop shape is more rounded in shape, has a bulkhead on three sides to contain the waste, and a hole on the top side, roughly finger sized, to enable the bag to be pushed through the raised lip to the thumb indentation. It has a gradual slope from one end to the end of the bulkhead. The scoop and handle are rounded and smooth finished to snap to the paddle. The surface has a raised lip around three sides. The end of the handle has a male connection that fits into the female connection part of the bag holder. All parts of the handle are smooth, rounded and made of polypropylene plastic.
The Paddle. The surface of the paddle is flat, smooth and is a curved shape. It is slightly smaller in length and smaller in width which enables it to easily fit inside the portable scoop. The handle of the paddle is also shortened in length and smaller in width; it has rounded edges and a thumb indentation as well. The handle is tapered at the top to conform to a hand. Disposable bag number two fits over the paddle section to protect it from excrement.
The Carry Bag. This part is made of nylon, is 6.25 inches wide and 6.25 inches long. It has an open top for the easy access and has two snap button fasteners which allow it to attach to the bag fastener. The purpose of this bag is to temporarily hold the waste that is contained in the disposable plastic bag until appropriate trash container is located.
The Removable Bag Fastener. This is a frame assembly which enables everything to fit together and be carried with the bag. It is designed with a slight vertical curve on the back side for comfort while carrying. It has a notch and a hole for the back of paddle handle to snap through. There is a square cut—out on the side of the frame handle for fingers to easily remove the paddle and scoop from this frame with pressure.
The Belt Loop and Swivel Mechanism. This part is located at the top, back side of the removable bag fastener and is designed for the fastening to a belt, collar, or retractable leash mechanism. It is designed to swing freely and hang vertically on the person or the dog at all times. The end of the swivel has a tight opening to allow for a belt or leash and is 7.0 inches long. The second part is designed to fit the retractable leash handle mechanism. It is curved and longer but is part of the same piece. The overall length of the loop is 1.69 inches. The swivel is located at the center top portion. The small plastic dowel is permanently affixed to the belt loop. It is a plastic dowel, smaller in circumference than the hole in the removable bag fastener. The swivel mechanism is long enough to go through the hole and protrude slightly. The tip of the dowel is slightly larger in circumference to allow it to remain in place after pushed through during assembly. The purpose of this design is to allow the total assembly to hang and swing freely while walling or jogging.
